(19) United States
(12) Patent Application Publication
(10) Pub. No.: US 2010/0161401 A1
(43) Pub. Date: Jun. 24, 2010

(54) INCENTIVE PROVIDING SYSTEM FOR INCREASE OF VISITORS ON INTERNET SITE AND METHOD THEREOF

(76) Inventor: Chang-Keun Lee, Seocho-gu (KR)

Correspondence Address: SHERR & VAUGHN, PLLC, 620 HERNDON PARKWAY, SUITE 320, HERNDON, VA, 20170, US

(21) Appl. No.: 12/600,473

(22) PCT Filed: Apr. 30, 2008
(86) PCT No.: PCT/KR2008/002440

§ 371 Date: Nov. 17, 2009

(30) Foreign Application Priority Data
May 22, 2007 (KR) 10-2007-0049732
Apr. 29, 2008 (KR) 10-2008-0039843

(51) Int. Cl. G06Q 30/00; G06F 15/16; G06Q 20/00

(52) U.S. Cl. 705/14.23; 705/14.36; 705/14.39; 709/219

(57) ABSTRACT

A system and method for providing an incentive to increase visitors to an Internet site provides a new type of coin search engine service named gold click to a plurality of unspecified users through the search engine of a coin search portal site. The system includes a coin search portal server including an automatic information processor, a cybercoin generator and a program transmitter, a Web publisher server connected to the coin search portal server through an online contract and providing an incentive to visitors, and a user server connected to the coin search portal server and receiving a gold click search service from the coin search portion server. Further, the method is accomplished by sequentially performing a site linking step, a cybercoin arranging step, a coin information providing step, a membership joining step, a coin accumulating step, and an associated marketing step through a series of system constituents.

### TECHNICAL FIELD

The present invention relates to a system and method for providing an incentive to increase visitors to an Internet site, and more particularly, to a system and method for providing an incentive to increase visitors to an Internet site, which differentially distribute preset amounts of products and cash to various operators' sites, which are found through a search function of a portal site, according to a preset allocation rate and amount, arrange the distributed products and cash in a cybercoin (or cybermoney) form, and enable users, who visit the operators' sites of interest, to selectively collect and accumulate the arranged cybercoin using a surfing bag program, thereby making it possible to create a new type of Internet profitable model.

### BACKGROUND ART

In various fields such as government, economy, society, culture, education, business, and so on, websites (including homepages) prepared for the purpose of providing information are typical online information providing media that induce a plurality of unspecified users to visit them through the Internet, and thereby enable the users to obtain their own desired information without regard to time and space anytime anywhere. These websites are discriminated by registered homepage addresses or uniform resource locators (URLs), and induce the users to gain access thereto.

However, the websites (and Web documents) prepared for this purpose amount to billions of cases per field, namely are too many to count. For this reason, each website operator is seriously troubled about what kind of procedure and method he/she uses to invite the unspecified users to visit the website operated by him/her, and how many of the unspecified users he/she invites to visit the website operated by him/her.

For example, when the website of the operator is relatively frequently exposed due to an increase in the number of visitors, the recognition and popularity of a website operating subject, i.e. a company or an individual, is naturally increased. Further, when the information provided through the website is associated with products, the advertisement effect of the products is broadly spread to increase sales of the operator as well as discover a new potential consumer, thereby endowing an effect of inducing the discovered consumer to purchase the products, and causing the users to actively communicate with each other.

Thus, most website operators typically use a large-scale portal site, such as Yahoo, Naver, Empass, Daum, Google, Overture, etc., all of which provide a keyword search engine service, as means for securing a regular visitor through service, such as information search or community, which can be regularly used by the user, and more efficiently exposing their own individual websites through the Internet.

Thus, this portal site provides the keyword search engine service in a manner such that, when the user inputs information (search word) desired by him/her into a search window, subject matter-based contents (website of the corresponding operator and various Web documents) corresponding to the search word is linked to the Web page of the portal site, and then, when the user selects and clicks the linked content, the user can enter the clicked operator website and Web document.

However, the individual operator websites and various Web documents, which are exposed by the keyword search function of the portal site, are very enormous as well. Thus, each individual website operator takes an interest in how the operator places the website operated by him/her or the Web document at an upper position of a searched page of the portal site which is followed by the search words input by the users.

Accordingly, most portal sites, which have recently been opened and operated, selectively provide search engine service of an Overture or Google type as means for eliminate the trouble from the individual website operators.

Here, first, the Overture type search engine service is designed to cause the individual website operators, who want the number of visitors to increase, to determine a price per click (a kind of site exposure advertising expenditure paid to a corresponding search engine service provider, for example if one of the website operators fixes the price of 200 Won per click in return for inducing a visit of one user, and then makes a successful bid, the amount of 2,000,000 Won is paid to the corresponding search engine service provider when ten thousand clicks are done by visits of ten thousand users) through a real-time bidding system, to cause the websites to be linked in the order knocked down for the click price higher than that of another competitive operator, and to expose the searched results on the upper position of the Web page of the portal site in the order in which the click prices are high when the users input the search word.

In contrast, the Google type search engine service is designed to cause the individual website operators, who want the number of visitors to increase, to determine a price per click (site exposure advertising expenditure) through a real-time bidding system, to calculate overall popularity of the website such as the number of visits made by the existing users, a volume of information, the number of linked sites, etc., to cause the searched results to be linked in the order in which the popularity of the websites is high when the users input the search word, and to expose the searched results on the upper position of the Web page of the portal site in that order.

However, a series of portal sites providing the aforementioned Overture or Google type search engine service enable anyone to obtain information through the keyword search and the resultant Web surfing regardless of membership as long as the obtained information is not specialized fee-charging information. As such, the search engine service sometimes induces malicious and strategic click frauds, thereby charging overrated advertising expenditures from the individual websites. This service also provides seriously incorrect search results on the user access data of the individual websites. In particular, since it is impossible to acquire correct information (e.g., gender, age, residence, vocation and access time zone) of the visitors to the operator site, it is also difficult to carry out associated marketing (e.g., an advertisement via e-mail or short messaging service) targeted to the visitors.

Accordingly, the above described search service of the prior art has problems such as very poor efficiency in that effective visitor analysis or resultant secondary marketing is not expectable even though the individual site operators are executing expensive site exposure advertising expenditures.

As described in a different way, the search service carried out, for example, by Overture or Google does not provide any incentive to the visitors even though the advertisement expenditure is acquired based on the visitors. According to this type of service, a website operator has to pay the total amount of advertisement expenditure due to the exposure when he/she wants his/her website to be on the upper position of the Web page as the result of searching, but the service provider (e.g., Overture or Google) is forced to defray the total amount of the advertisement expenditure. That is, this type of search service is merely a very irrational and one-sided profit gaining process, but does not provide a solution or a plan how to stimulate the expectation of the users and thereby actively attract the users to the operator's site. Due to these problems, it can be understood that the search service is very inefficient.

Therefore, the individual website operators who want to attract more visitors to their websites are seeking for a specialized search service or engine, which is cost-efficient and more systematic, provides more frequent and friendly contacts with the visitors, and provides a chance to carry out marketing to the visitors.

On the other hand, the users also want the development of a new type of Internet service or search engine, which is more equable, more rational and more economical, so that they can not only acquire necessary information but also take an opportunity of creating profits by receiving the incentive through the visit of the operator site.

### DISCLOSURE OF INVENTION

### Technical Problem

The present invention has been made to solve the foregoing problems with the prior art, and therefore an object of the present invention is to provide a system and method for providing an incentive to increase visitors to an Internet site, which differentially distribute preset amounts of products and cash to various individual websites (and Web documents), which are searched and exposed through a coin search portal operator server according to a preset allocation rate and amount using a new type of search engine service system named gold click, arrange the distributed products and cash in the forms of cybercoin and cyber product coupon at unspecified arbitrary positions (Web pages), further offer a coin search service system (coin search input window) as an additional function, thereby making it possible to perform a typical keyword search function for acquiring information and a differentiated coin search function for obtaining wealth.

Another object of the present invention is to provide a system and method for providing an incentive to increase visitors to an Internet site, which mainly search, for information, only individual websites (and Web documents) to which coin (cybercoin or cyber product coupon) is allocated when a search word is input through a coin search input window, arrange and expose the searched information in the order based on a holding amount of coin (total amount of incentive provided for a visitor), enable users to identify coin balances of the exposed websites through an auxiliary information window when the users attempt to access the exposed individual website as a target, enable the user to selectively collect and accumulate the coin allocated to each operator website by clicking a mouse using a surfing bag program downloaded and installed when membership is joined according the series of pieces of coin information, enable the users to change the accumulated cybercoin into cash when used regardless of on-line and off-line, thereby giving a new meaning of investing means to the users, providing more efficient, systematic, targeted Internet search technique to individual website operators, and making it possible to increase a rate at which the users visit the websites.

Another object of the present invention is to provide a system and method for providing an incentive to increase visitors to an Internet site, which make it possible to obtain correct data about gender, age, vocation, residence, and access time zone of a user using a gold click search service system on the basis of basic information provided when the user joins membership and of incentive account information acquired by the user, more systematically analyze advertising effects using the information obtained in this way, enable an operator of the gold click search service system to provide brief information such as visit situations of the user to the individual site operators, induces the individual site operators to request secondary marketing to the users visiting the corresponding site on the basis of the brief information, enable the operator of the gold click search service system to additionally provide mobile service such as short messaging service and mailing service at the request so as to make associated marketing possible, add a predetermined amount of cybercoin to an advertising mail transmitted online in the mailing service, and make it possible for the corresponding user to accumulate product and cash through e-mail, thereby providing more advanced technical specialty and differentiation in marketing strategy and Internet search technique through the online.

### Technical Solution

According to an aspect of the present invention, there is provided a system for providing an incentive to increase visitors to an Internet site, which includes a coin search portal server including an automatic information processor, a cybercoin generator and a program transmitter, a Web publisher server connected to the coin search portal server through an online contract and providing the incentive to visitors, and a user server connected to the coin search portal server and receiving a gold click search service from the coin search portion server.

According to another aspect of the present invention, there is provided a method for providing an incentive to increase visitors to an Internet site, which includes a site linking step, a cybercoin arranging step, a coin information providing step, a membership joining step, a coin accumulating step, and an associated marketing step, which are sequentially performed through a series of system constituents.

### ADVANTAGEOUS EFFECTS

As set forth above, according to the present invention, the method for providing an incentive to increase visitors to an Internet site differentially distributes preset amounts of products and cash to various individual websites (and Web documents), which are searched and exposed through a coin search portal operator server according to a preset allocation rate and amount using a new type of search engine service system named gold click, arranges the distributed products and cash in the forms of cybercoin and cyber product coupon at unspecified arbitrary positions (Web pages), further offers a coin search service system (coin search input window) as an additional function, so that it is possible to perform a typical keyword search function for acquiring information and a differentiated coin search function for obtaining wealth.

Further, the method mainly searches, for information, only individual websites (and Web documents) to which coin (cybercoin or cyber product coupon) is allocated when a search word is input through a coin search input window, arrange and expose the searched information in the order based on a holding amount of coin (total amount of incentive provided for a visitor), enables users to identify coin balances of the exposed websites through an auxiliary information window when the users attempt to access the exposed individual website as a target, enables the user to selectively collect and accumulate the coin allocated to each operator website by clicking a mouse using a surfing bag program downloaded and installed when membership is joined according the series of pieces of coin information, enables the users to change the accumulated cybercoin into cash when used regardless of on-line and off-line, so that it can give a new meaning of investing means to the users, provide more efficient, systematic, targeted Internet search technique to individual website operators, and increase a rate at which the users visit the websites.

### BRIEF DESCRIPTION OF THE DRAWINGS

FIG. 1 is a schematic view illustrating a system for providing an incentive to increase visitors to an Internet site according to the present invention.

FIG. 2 is an overall conceptual view illustrating a method for providing an incentive to increase visitors to an Internet site according to the present invention.

FIG. 3 is a flow chart illustrating a method for providing an incentive to increase visitors to an Internet site according to the present invention.

FIG. 4 is a schematic view illustrating the configuration of a main Web page of a coin search portal operator server applied to the present invention.

FIG. 5 illustrates the screen configuration of an account accumulation auxiliary window provided by a surfing bag program according to the present invention.

FIG. 6 illustrates the configuration of an advertising message transmitted through an associated marketing step according to the present invention.

### MAJOR REFERENCE NUMERALS AND SYMBOLS OF THE DRAWINGS

1: coin search portal operator server
2: individual Web publisher server
3: user server
S1: site linking step
S2: cybercoin arranging step
S3: coin information providing step
S4: membership joining step
S5: coin accumulating step
S6: associated marketing step

### BEST MODE FOR CARRYING OUT THE INVENTION

Hereinafter, a method for providing an incentive to increase visitors to an Internet site according to the present invention will be described in detail with reference to the accompanying drawings.

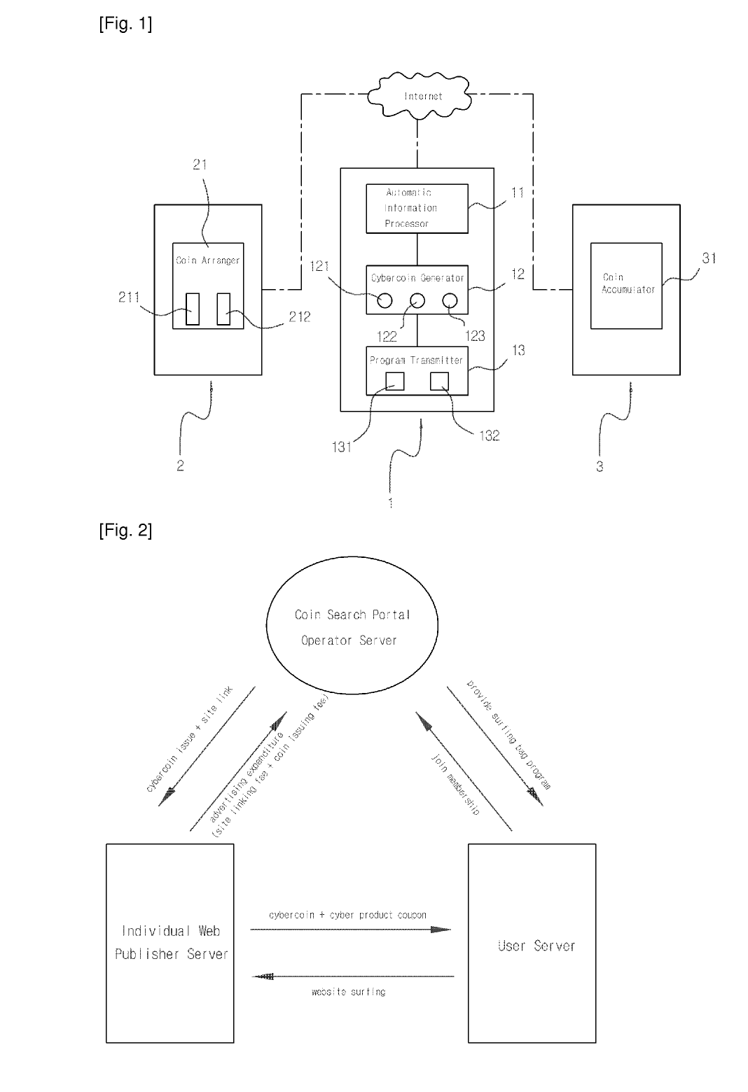

FIG. 1 is a schematic view illustrating a system for providing an incentive to increase visitors to an Internet site according to the present invention. As for a series of configuration of the system, the system includes a coin search portal operator server 1, individual Web publisher servers 2, and user servers 3.

The first constituent of the system according to the present invention, the coin search portal operator server 1, constitutes a main portal website of the present invention which is for providing a coin search service named a gold click through the Internet. The coin search portal operator server 1 includes an automatic information processor 11. Preferably, the coin search portal operator server 1 further includes a cybercoin generator 12, and a program transmitter 13.

At this time, the automatic information processor 11 of the coin search portal operator server 1 is a typical online intermediating means that classifies the individual Web publisher servers 2 and the user servers 3, which will be described below, according to a service type, and is connected with these servers on the Internet in real time. This automatic information processor 11 constitutes another server, and provides membership service, character information and message transmission service, menu operation service based on creation of a Web browser, and data transmission service for various data such as voice, a moving picture, a still image, and so on, through the automatic information processor 11 of the other server.

Further, the cybercoin generator 12 of the coin search portal operator server 1 is a kind of automatic operating program for supplying cybercoin to the individual Web publisher servers 2, which will be described below. As illustrated in FIG. 1, this cybercoin generator 12 includes a Web program made up of a basic coin generation mode 121, a character coin generation 122, and a product coupon generation mode 123.

Further, the program transmitter 13 of the coin search portal operator server 1 is a kind of data download processor that transmits a coin arrangement program 131 to the individual Web publisher servers 2, which will be described below, and that transmits a surfing bag program 132 to the user servers 3. This program transmitter 13 includes a file storage that stores and manages the corresponding programs 131 and 132.

Further, the second constituent of the system according to the present invention, each individual Web publisher server 2, constitutes a typical Web server that is established in order to provide constituents, for instance information about organizations, enterprises or individuals, of each individual online website hoping visitors to increase. Each individual Web publisher server 2 further includes a coin arranger 21 that receives the coin arrangement program 131 from the aforementioned coin search portal operator server 1 and then installs and operates the received coin arrangement program 131.

At this time, the coin arranger 21 constitutes another Web server in which the coin arrangement program 131 is executed. The coin arranger 21 includes a random coin arranger 211, which distributes cybercoin, which are received from the coin search portal operator server 1, in a random format fashion in which nominal par of the cybercoin is not exposed, namely in a roulette algorithm format in which nominal par of the cybercoin is not exposed until the cybercoin is clicked by a visit of the user, and then arranges the distributed cybercoin on an arbitrary Web page of each individual Web publisher server 2, and an optional coin arranger 212, which distributes the cybercoin in a planned format, namely in a preset algorithm format, and then arranges the distributed cybercoin on a designated Web page of each individual Web publisher server 2 in a manner such that the nominal par of the cybercoin is exposed.

Further, the third constituent of the system according to the present invention, the user servers 3 are a plurality of unspecified individual Web servers required to obtain various pieces of information through the Internet. Each user server 3 preferably includes a coin accumulator 31 that receives the surfing bag program 132 from the aforementioned coin search portal operator server 1 and then installs and operates the received surfing bag program 132.

Thus, the present invention having a series of system constituents as described above realizes another differentiated type of method for providing an incentive to increase visitors to an Internet site using the established system. An exemplary embodiment of the incentive providing method having another characteristic configuration will be described in detail with reference to the accompanying drawings.

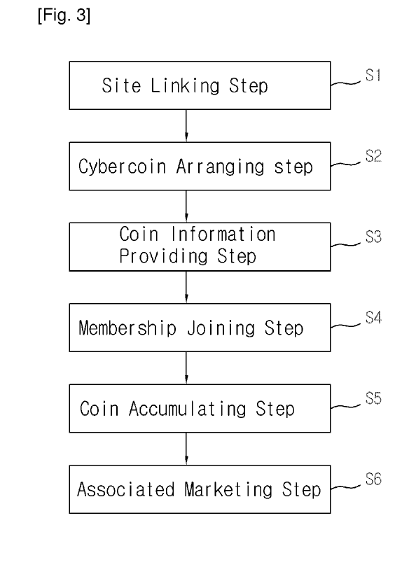

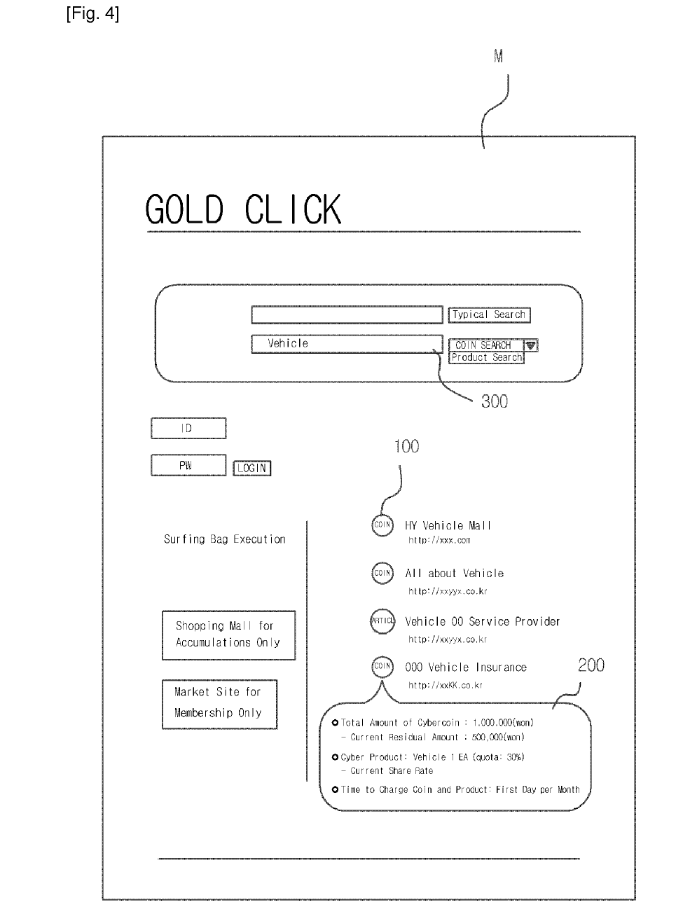

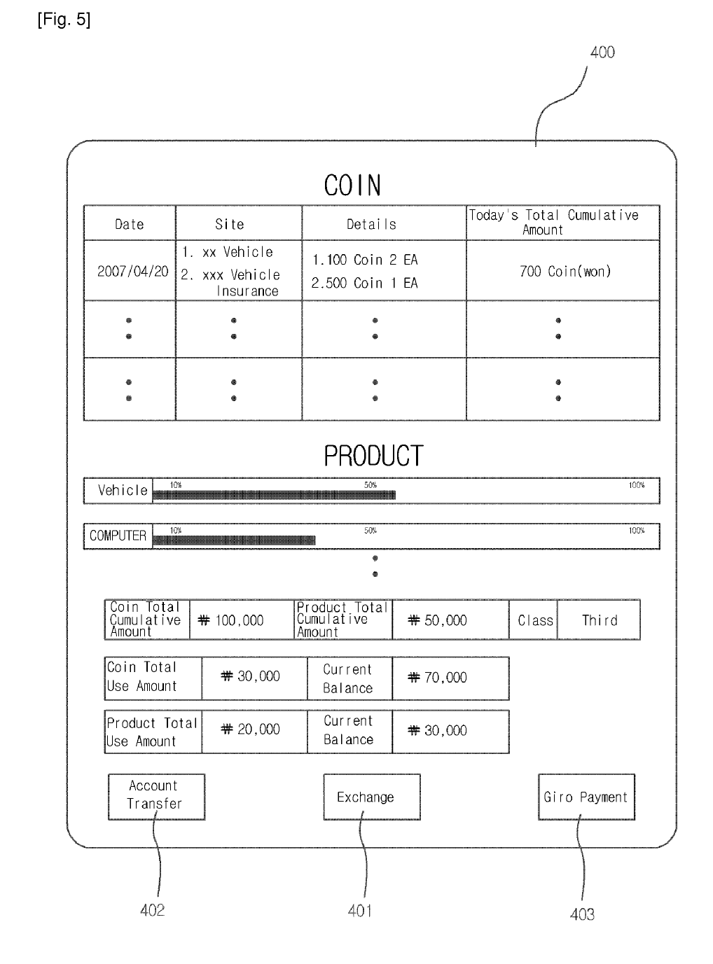

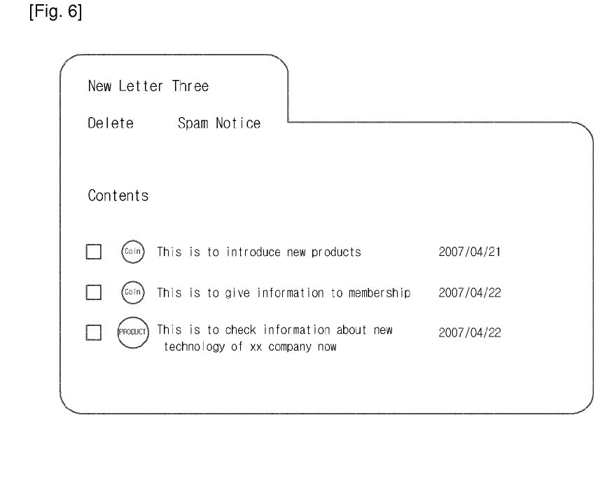

FIG. 2 is an overall conceptual view illustrating a method for providing an incentive to increase visitors to an Internet site according to the present invention. FIG. 3 is a flow chart illustrating a method for providing an incentive to increase visitors to an Internet site according to the present invention. FIG. 4 is a schematic view illustrating the configuration of a main Web page of a coin search portal operator server applied to the present invention. FIG. 5 illustrates the screen configuration of an account accumulation auxiliary window provided by a surfing bag program according to the present invention. FIG. 6 illustrates the configuration of an advertising message transmitted through an associated marketing step according to the present invention. Now, a series of steps for the incentive providing method will be described.

The incentive providing method includes a site linking step S1, a cybercoin arranging step S2, a coin information providing step S3, a membership joining step S4, a coin accumulating step S5, and an associated marketing step S6.

Here, first, the site linking step S1 includes a process of opening a search service providing means named a gold click, namely a coin search portal operator server 1, on the Internet, a process of linking the opened coin search portal operator server 1 with a individual Web publisher server 2 hoping visitors to increase by mutually making an online contract (a scope of the incentive to be provided to an Internet visitor, a quantity with which the total amount of the incentive is exchanged to cybercoin and cyber product coupon, a link service fee, a data analysis fee, a search word, and so on), and a process of linking the individual Web publisher server 2 to the coin search portal operator server 1.

More specifically, as illustrated in FIG. 2, the coin search portal operator server 1 and the individual Web publisher server 2 are connected online on the Internet, and then the individual Web publisher server 2 transmits the online contract document (the total amount of the cybercoin to be provided to the visitor to the Internet site, the site link service fee to be paid to the coin search portal server, the exchange quantity of the cybercoin and cyber product coupon, the data analysis fee, the search word, and so on) to the automatic information processor 11 of the coin search portal operator server 1 in the form of a text file. Further, when an advertising expenditure summing up the site link service fee and total amount of the incentive according to the contract is sent online to an account linked to the coin search portal operator server 1, the coin search portal operator server 1 processes the paid advertising expenditure by obtaining the site link service fee as a link agency fee, and by converting the total amount of the incentive, which is a site visiting expense to be provided to the user server 3, into the cybercoin through the cybercoin generator 12 of the coin search portal operator server 1, storing and processing the converted cybercoin in the form of a coin data file, and online transmitting the processed coin data file to the individual Web publisher server 2.

At this time, the nominal par of the cybercoin transmitted to the individual Web publisher server 2 is variably set according to the online contract made between the individual Web publisher server 2 and the coin search portal operator server 1. Further, the transmitted cybercoin is generated into unit-specific necessary quantities expressed by its nominal par by the request of the individual Web publisher server 2.

For example, in the case in which the expressed form of the cybercoin requested by the individual Web publisher server 2 according to the contract is a basic image form in which the nominal par is simply expressed, the coin search portal operator server 1 is adapted at the request so that, when information about the cybercoin to be generated, namely, an instruction for the nominal par and quantity such as 10 Won and 5000, 100 Won and 2000, 1000 Won and 500, or the like, is input into the basic coin generation mode 121 of the cyber coin generator 12, the basic coin generation mode 121 calculates the cybercoin corresponding to the instruction according to the quantity, completes a file in which one coin data is stored, and transmits the completed coin data file to the coin arranger 21 of the individual Web publisher server 2.

Further, similar to the aforementioned method, in the case in which the expressed form of the cybercoin requested by the individual Web publisher server 2 according to the contract is a processed image form in which the nominal par is represented to an icon converted into a character, the coin search portal operator server 1 is adapted at the request so that, when an corresponding instruction is input into the character coin generation mode 122 of the cyber coin generator 12, the character coin generation mode 122 generates the cybercoin, an amount of which is represented to an icon image converted into the character, particularly a figure devised into an animal shape, a tool shape, or another new shape, completes a file in which coin data is stored, and transmits the completed coin data file to the coin arranger 21 of the individual Web publisher server 2.

In addition, similar to the aforementioned method, the cybercoin provided to the individual Web publisher server 2 by the payment of the advertising expenditure is not simply limited to the cybercoin, but it can be provided as the cyber product coupon for product compensation. This cyber product coupon is based on a predetermined list of commodities designated by the coin search portal operator server 1. The list of commodities can be variously designated from a real estate to typical goods of life such as a vehicle, a washing machine, a computer, and a digital camera.

In the case in which the expressed form of the cybercoin requested by the individual Web publisher server 2 according to the contract is the cyber product coupon, the coin search portal operator server 1 is adapted at the request so that, when an corresponding instruction is input into the product coupon generation mode 123 of the cyber coin generator 12, the product coupon generation mode 123 generates the cybercoin into an image of the cyber product coupon divided into multiple numbers, completes a file in which product coupon data is stored, and transmits the completed cyber product coupon data file to the coin arranger 21 of the individual Web publisher server 2.

At this time, preferably, since the commodities for the product compensation can require expenses that are excessive for one individual Web publisher server 2 to defray according to the kind, the individual Web publisher servers, each of which makes a contract with the coin search portal operator server 1, distribute the necessary total expenses corresponding to the commodities, and share the expenses according to a distribution rate. In addition, the individual Web publisher servers also distribute the cyber product coupon into a plurality of divided cyber product coupons in proportion to a price of one product compensated for the cyber product coupon, and then share the divided cyber product coupons with each other.

In greater detail, as in Table 1 below, in the case in which the provided product is a vehicle, the price of which amounts to 30,000,000 Won, the first individual Web publisher server 2 (the first advertiser) makes a contract to defray the expense of 9,000,000 Won corresponding to 30% of the overall price of the vehicle, and then requests the coin search portal operator server to generate the expense of 9,000,000 Won into 9000 cyber product coupons worth 1000 Won through the contract text document file. Alternatively, the second individual Web publisher server 2 (the second advertiser) makes a contract to defray the expense of 6,000,000 Won corresponding to 20% of the overall price of the vehicle, and then requests the coin search portal operator server to generate the expense of 6,000,000 Won into 6000 cyber product coupons worth 1000 Won. Thereby, the individual Web publisher servers receive the generated cyber product coupons.

TABLE

| | | Share | |
|---|---|---|---|
| Kind of Product | Enterprise | Rate | Cyber Product Coupon |
| Vehicle (3,000,000 | First Advertiser | 30% | 1000 Won × 9000 |
| Won) | Second Advertiser | 20% | 1000 Won × 9000 |
| | . . . | . . . | . . . |

Further, the cyber coin arranging step S2 includes a process of receiving the cybercoin or the cyber product coupons, which is generated and provided from the coin search portal operator server 1, from the coin arranger 21 of each individual Web publisher server 2, and a process of selectively distributing the received cybercoin or cyber product coupons on the Web pages of the individual Web publisher server 2.

In the cyber coin arranging step S2, first, the coin arrangement program 131 is downloaded from the program transmitter 13 of the coin search portal operator server 1, and is installed on the coin arranger 21 of each individual Web publisher server 2. The coin arranger 21, on which the coin arrangement program 131 is installed, receives the data file of the cybercoin or the cyber product coupon generated through the site linking step S1. In the coin arranger 21, the data of the received data file of the cybercoin or the cyber product coupon is input into the random coin arranger 211 having a roulette algorithm processing format, and is allocated as an image capable of checking only existence of the cyber coin so as to have random quantity and arrangement without exposing the nominal par of the cybercoin on the Web pages of the individual Web publisher servers 2 divided by tens of text and image file lists, or the data of the received data file of the cybercoin or the cyber product coupon is input into the optional coin arranger 212 having a preset algorithm processing format, and is selectively allocated according to a preset quantity and a positional arrangement to which the user is expected to pay attention with the nominal par of the cybercoin shown on the Web pages of the individual Web publisher servers 2 divided by tens of text and image file lists.

At this time, in the cyber coin arranging step S2, most products compensated by the cyber product coupons allocated to the Web pages of the individual Web publisher servers 2 are relatively expensive. Thus, a quantity of the cyber product coupons compensating for the products is set to one corresponding to a predetermined target value. When the user collects and accumulates the corresponding quantity of cyber product coupons, he/she is adapted to obtain the product compensated by the accumulated cyber product coupons.

Further, the coin information providing step S3 includes a process of representing whether or not the cybercoin and the cyber product coupon are provided on one side of the Web page of each website in conjunction with the contents of many individual Web publisher servers 2, i.e. individual websites, linked to the coin search portal operator server 1 through the online contract. As illustrated in FIG. 4, the representation of whether or not the cybercoin and the cyber product coupon are provided is carried out by the image of the icon 100 converted into the character, namely by a mark of, for instance, a figure devised into an animal shape, a tool shape, or another new shape, and then is displayed on the main Web page M of the coin search portal operator server 1.

At this time, the icon 100, which is converted into the character in order to represent whether or not the cybercoin and the cyber product coupon are provided, is clicked using a mouse. In this case, as illustrated in FIG. 4, an auxiliary window 200 is displayed, and provides total amounts and current balances of the cybercoin and the cyber product coupon allocated to each individual Web publisher server 2, and a charging time caused by consumption of the cybercoin.

Meanwhile, in the coin information providing step S3, the coin search portal operator server 1, which represents whether or not the cybercoin and the cyber product coupon are provided, further includes a new coin search window 300 having option menu icons of the cybercoin and the cyber product coupon on the main Web page M thereof, as illustrated in FIG. 4. The user clicks one of the option menu icons of the cybercoin and the cyber product coupon, inputs a search word into the coin search window 300, and then strikes an Enter key. Thus, the information about (the websites of) the individual Web publisher servers 2, which provide the user with the incentive based on the cybercoin and the cyber product coupon, is searched and provided in the order of the total amount of the incentive on the Web page of the coin search portal operator server 1. In particular, the websites of the individual Web publisher servers 2 linked for the search have differential link orders ranked and displayed according to holding amounts of the cybercoin and the cyber product coupon.

Further, the membership joining step S4 includes a process of connecting the user servers 3 with the coin search portal operator server 1 over the Internet, and a process of inducing a plurality of unspecified persons who use the Internet, i.e. a plurality of users, to be classified into fee-charging membership and free membership so as to be joined with the user servers through selective online subscription application. In this membership joining step S4, as in the typical online service, first, each user server 2, which wants to use the services of the coin search portal operator server 1, fills out a predetermined online subscription form by consenting the terms of services, and then transmits online a text document of the online subscription form to the automatic information processor 11 of the coin search portal operator server 1. In this case, the coin search portal operator server 1 issues identification and password through the automatic information processor 11. In particular, only for the fee-charging membership, that is, the fee-charging user server 3 among the joined membership, the surfing bag program 132, as a means required to collect and accumulate the cybercoin and the cyber product coupon, stored in the program transmitter 13 of the coin search portal operator server 1 is transmitted to the coin accumulator 31 of the user server 3, and is automatically installed there.

Here, with respect to the service fee fixed when the user server 3 is joined as the fee-charging membership, the user server 3 downloads and automatically installs the surfing bag program 132, accumulates a predetermined amount of cybercoin through the coin search service, and subtracts an amount corresponding to a predetermined rate from the accumulated total amount of cybercoin in the name of subscription fee and service fee.

At this time, the surfing bag program 132 transmitted to and installed on the coin accumulator 31 of the fee-charging user server 3 functions to stably manage cumulative accumulation situation and use situation of the cybercoin and the cyber product coupon. As illustrated in FIG. 5, this surfing bag program 132 provides an account accumulation auxiliary window 400, which is designed to display date-specific cumulative amounts of the cybercoin and the cyber product coupon, total cumulative amounts and their resultant point classes of the cybercoin and the cyber product coupon, use amounts and current balances of the cybercoin and the cyber product coupon, and a list of compensation products corresponding to the cybercoin and the cyber product coupon in the form of letter and graph, and a mouse icon (not shown) converted into the character having the shape of a rake, pincer, a coin bank, or the like.

Further, the total cumulative amounts and their resultant point classes of the cybercoin and the cyber product coupon are offered to calculate a credit class of the user server 3 step by step. The point is sequentially provided on the basis of the credit classes divided according to the step. In the case in which the point reaches a preset target value, the coin search portal operator server 1 additionally provides a separate gift provision service to the corresponding user server 3 on the basis of the class of the reached point.

In addition, the account accumulation auxiliary window 400 is another constituent having an auxiliary function, and additionally provides an exchange request toolbar 401 for requesting money exchange of the cumulative cybercoin, a cash transfer request toolbar 402 for requesting automatic transfer to an bank account of the user in order to change the cumulative cybercoin into cash, a giro request toolbar 403 for paying public fees, and an authorized certificate (not shown) for preventing a series of pieces of transaction information from leaking out.

Further, the coin accumulating step S5 includes a process of freely surfing the websites of the individual Web publisher servers 2 to which the cybercoin and the cyber product coupon are allocated using the surfing bag program 132 installed on each user server 3 having a status of the fee-charging membership capable of using the services provided by the coin search portal operator server 1, and a process of collecting and accumulating the cybercoin and the cyber product coupon allocated to the visited website by clicking the mouse.

In the coin accumulating step S5, when the cybercoin or the cyber product coupon, which is searched using the mouse icon (not shown) converted into the character in the surfing bag program 132 downloaded to and installed on the coin accumulator 131 of the user server 3 through the aforementioned membership joining step S4, is clicked, the clicked cybercoin or cyber product coupon is stored as the data-specific total cumulative amount of the account accumulation auxiliary window 400.

Further, the associated marketing step S6 includes a process of surfing the websites of the individual Web publisher servers 2 through an account of the coin search portal operator server 1, and a process of obtaining information about each user server 3 that collects and accumulates the cybercoin and the cyber product coupon. When each individual Web publisher server 2 pays a predetermined amount of other advertising expenditure to the coin search portal operator server 1 using the information obtained through the associated marketing step, and then requests target marketing, the coin search portal operator server 1 provides a short messaging service for advertisement transmission and a mailing service to which the cybercoin or the cyber product coupon is attached through a mobile service or an e-mail associated with each user server 3 on the basis of the information (age, gender, access time zone, mobile phone or e-mail of the user) obtained and stored in the automatic information processor 11 through the membership joining step S4.

At this time, the cybercoin or the cyber product coupon transmitted together with the mobile service or the e-mail associated with each user server through the associated marketing step S6 is defrayed by each individual Web publisher server 2 requesting this target marketing.

In particular, in the associated marketing step S6, the cybercoin or the cyber product coupon transmitted together with the mobile service or the e-mail has the icon converted into the character additionally represented on one side of a title of the transmitted advertisement as illustrated in FIG. 6, in order to enable each user server 3 to check whether or not the cybercoin or the cyber product coupon is attached. When the user server 3 opens the mail to click the cybercoin or the cyber product coupon attached to the mail through this representation, the clicked cybercoin or cyber product coupon is accumulated in the account accumulation auxiliary window 400 of the surfing bag program 132 installed on the coin accumulator 31 of the user server 3.

Meanwhile, the coin search portal operator server 1 can additionally operate an online shopping mall for accumulations only which can perform purchase of the goods and exchange of products using the cybercoin and the cyber product coupon which the user server 3 accumulates using the surfing bag program 132. Particularly, the coin search portal operator server 1 can further operate another exclusive transaction conciliation server, i.e. a market site server for membership only, which can give up the process of collecting and accumulating the cyber product coupon before the accumulated amount reaches the target value, sell the cyber product coupon accumulated in the meantime to another person, and thereby change the cyber product coupon into cash.

Thus, the method for providing an incentive to increase visitors to an Internet site according to the present invention provides the services through a series of steps as described above.

According to this method, the predetermined amounts of cybercoin and the cyber product coupon are accumulated in the account accumulation auxiliary window 400 using the surfing bag program 132 provided from the coin search portal operator server 1. In this state, when the cybercoin is to be used as cash, the cash transfer request toolbar 402 provided to the account accumulation auxiliary window 400 is clicked such that the cybercoin is transferred to a transaction bank account linked with the user server 3. Further, when the purchase of the products is required through a foreign transaction site using the cybercoin, the exchange request toolbar 401 provided to the account accumulation auxiliary window 400 is clicked to request exchange into the currency of a corresponding country. In addition, when various public fees and product purchase expenses are to be paid using the accumulated cybercoin, the giro request toolbar 403 provided to the account accumulation auxiliary window 400 is clicked to access a corresponding payment site, so that the accumulated cybercoin is changed into cash.

At this time, the cybercoin accumulated in the account accumulation auxiliary window 400 can be used like the cash at all times regardless of use conditions. Thus, the toolbars provided to the account accumulation auxiliary window 400 can selectively increase or decrease necessary menu options in addition to the account transfer request, the exchange request, and the payment request for the public fees and product purchase expenses, which does not depart from the scope of the present invention.

Meanwhile, the aforementioned incentive providing method using the system for providing an incentive to increase visitors to an Internet site according to the present invention can be applied to blogs, cafes, mini homepages, etc. provided from the coin search portal operator server.

In detail, when the personal operation servers such as blogs, cafes, mini homepages, etc. pay the advertising expenditure summing up a service fee and a coin issuing fee through small amount payment to the coin search portal operator server 1, the coin search portal operator server 1 processes the paid advertising expenditure by obtaining the service fee as an agency fee, and by converting the coin issuing fee into the cybercoin through the cybercoin generator, and providing the converted cybercoin to the blogs, cafes, mini homepages, etc. of the personal operation servers in the form of a coin data file.

Thus, each personal operation server allocates the cybercoin to the corresponding blog, caf, mini homepage, etc. using the coin arrangement program 131, advertises information on allocation of the cybercoin through blog search results, and enables the visitor to acquire the allocated cybercoin, thereby promoting increase of the visitors. These series of methods have no difference compared with the incentive providing method using the system for providing an incentive to increase visitors to an Internet site as in the aforementioned embodiment.

Further, as described above, the incentive providing method using the system for providing an incentive to increase visitors to an Internet site according to the present invention is not simply limited to the services provided over the Internet. For example, the incentive providing method may be expanded and applied to a mobile service based on a mobile terminal, which does not depart from the scope of the present invention as well.

1-11. (canceled)

12. A system for providing an incentive to increase website visitors, comprising:
a coin search portal server (1) including an automatic information processor (11), a cybercoin generator (12) and a program transmitter (13);
a Web publisher server (2) connected online to the coin search portal server (1) by the automatic information processor (11), and including a coin arranger (21) which provides an incentive to visitors; and
a user server (3), including a coin accumulator (31), which is provided with a gold click from the coin search portal server (1) through an online connection by the automatic information processor (11).

13. The system according to claim 12, wherein the cybercoin generator (12) comprises a Web program including a basic coin generation mode (121) capable of automatic operation, a character coin generation mode (122) and a product coupon generation mode (123).

14. The system according to claim 12, wherein the coin arranger (21) includes:
a random coin arranger (211), which distributes cybercoin by a random format without disclosing a nominal par of the cybercoin; and
an optional coin arranger (212), which arranges a position of cybercoin and discloses the nominal par of the cybercoin so as to be distributed by a planned format.

15. A method for providing an incentive, using a system for increasing website visitors, comprising:
a site linking step (S1) of linking a coin search portal operator server (1) with an individual Web publisher server (2) to increase visitors by online contact, converting an amount of money corresponding to a coin issuing fee into cybercoin by a cyber coin generator (12) in response to a request from the linked individual Web publisher server (2), and transmitting the converted cybercoin in a form of a coin data file to a coin arranger (21) of the individual Web publisher server (2);
a cybercoin arranging step (S2) of receiving the coin data file and a coin arrangement program (131) from the coin search portal operator server (1) in the coin arranger (21) of the individual Web publisher server (2), installing the received coin arrangement program (131) in the coin arranger (21), and inputting the coin data file into the coin arrangement program (131) so as to allocate the cybercoin to the individual Web publisher server (2);
a coin information providing step (S3) of displaying a characterized icon, which represents whether to provide a list of the individual Web publisher server (2) linked to the coin search portal operator server (1) and the cybercoin, through a main Web page (M) of the coin search portal operator server (1), and causing the main Web page (M) to further include a coin search window (300);
a membership joining step (S4) of connecting a user server (3) through an automatic information processor (11) of the coin search portal operator server (1), issuing identification (ID) and password by classifying into charged membership and free membership according to online subscription by the user server (3), transmitting a surfing back program, necessary for cybercoin collection and accumulation, to the user server (3) joined as the charged membership through a program transmitter (13), and causing the transmitted surfing back program to be installed in a coin accumulator (31) of the user server (3) joined as the charged membership;
a coin accumulating step (S5) of surfing a website of the individual Web publisher server (2), to which the cybercoin is allocated, by using the surfing back program installed in the coin accumulator (31) of the user server (3) joined as the charged membership, clicking the cybercoin allocated to the website, and collecting and accumulating the clicked cybercoin in the coin accumulator (31) of the user server (3); and
an associated marketing step (S6) of acquiring information on the user server (3), which is surfing the website of the individual Web publisher server (2) in the coin accumulating step (S5), by the automatic information processor (11) of the coin search portal operator server (1), wherein the coin search portal operator server (1) provides, after having acquired the information on the user server (3), a short message service and a mailing service with cybercoin and a cyber product coupon attached thereto by at least one of a mobile service and an email service, linked to the user server (3), in response to a selective request from the individual Web publisher server (2) based on the information on the user server (3).

16. The method according to claim 15, wherein the cybercoin generator (12) completes the coin data file of the generated cybercoin in response to an inputted command, through one selected from the group consisting of: a basic coin generation mode (121) capable of automatic operation, a character coin generation mode (122) and a product coupon generation mode (123), by a request from the individual Web publisher server (2).

17. The method according to claim 16, wherein:
the cybercoin is provided as a cyber product coupon for product compensation through the product coupon generation mode (123) of the cybercoin generator (12);
the cyber product coupon is allocated to the website of the individual Web publisher server (2) as being divided into multiple numbers in proportion to a value of a compensation product; and
the user server (3) is allowed to acquire the compensation product when the coin accumulator (31) of the user server (3) has collected and accumulated the cyber product coupon, allocated to the website of the individual Web publisher server (2), in an amount corresponding to a predetermined target value.

18. The method according to claim 15, wherein the coin information providing step (S3) comprises: when a characterized icon displayed on a Web page of the coin search portal operator server (1) is clicked, displaying an auxiliary window (200), and providing a total amount of the cybercoin and the cyber product coupon, allocated to the website of the individual Web publisher server (2), a current balance and charging information due to consumption of the cybercoin.

19. The method according to claim 15, wherein:
the coin search window (300) of the main Web page (M) of the coin search portal operator server (1) includes an option menu icon of the cybercoin and an option menu icon of the cyber product coupon, and
when one of the option menu icons of the cybercoin and the cyber product coupon is clicked, and a search word is inputted into the coin search window (300), website information on the individual Web publisher server (2), to which an incentive is applied, is provided as a differentiated form.

20. The method according to claim 15, wherein the coin search portal operator server (1) operates a designated online shopping mall, in which products can be purchased by and exchanged with the cybercoin and the cyber product coupon accumulated in the coin accumulator (31) of the user server (3), and a market site server for membership only, which mediates selling and buying the accumulated cyber product coupon.

21. The method according to claim 15, wherein the surfing bag program (132) transmitted to and installed on the coin accumulator (31) of the user server (3) through the membership joining step (S4) includes:
an account accumulation auxiliary window (400), which displays date-specific cumulative amounts of the cybercoin and the cyber product coupon, total cumulative amounts and resultant point classes of the cybercoin and the cyber product coupon, use amounts and current balances of the cybercoin and the cyber product coupon, and a list of compensation products corresponding to the cybercoin and the cyber product coupon in the form of letter and graph; and
a mouse icon converted into a character.

22. The method according to claim 21, wherein the account accumulation auxiliary window (400) includes an exchange request toolbar (401) for requesting money exchange of the cumulative cybercoin, a cash transfer request toolbar (402) for requesting automatic transfer to an bank account of the user in order to change the cumulative cybercoin into cash, a giro request toolbar (403) for paying public fees, and an authorized certificate for preventing portions of transaction information from leaking out.
